(19) United States
(12) Patent Application Publication
(10) Pub. No.: US 2009/0320945 A1
(43) Pub. Date: Dec. 31, 2009

(54) FLOW SYSTEM WITH A FLOW RESTRICTER

(75) Inventors: Kasper Oktavio Schweitz, Hilleroed (DK); Martin Manscher, Valby (DK)

Correspondence Address: MCCORMICK, PAULDING & HUBER LLP, CITY PLACE II, 185 ASYLUM STREET, HARTFORD, CT, 06103, US

(73) Assignees: Cequr ApS, Nordborg (DK); Diramo A/S, Nordborg (DK)

(21) Appl. No.: 12/374,054

(22) PCT Filed: Jul. 14, 2007
(86) PCT No.: PCT/DK07/00361

§ 371 Date: Jun. 30, 2009

(30) Foreign Application Priority Data
Jul. 20, 2006 (DK) PA 2006 00998

(51) Int. Cl. F15D 1/00

(52) U.S. Cl. 137/561 R; 137/800

(57) ABSTRACT

A flow system, preferably a micro fluidic system, having a base part (4) with at least one flow path formed therein and a lid part (5) being attached to the base part (4) in such a manner that it covers the flow path(s). The flow path(s) comprise(s) a flow restrictor (1) and a flow channel comprising an inlet section positioned immediately upstream relatively to the flow restrictor (1). At least the inlet section of the flow channel has a cross section defining at least two distinct depths of the flow channel. This may be achieved by defining a centre section (3) and at least one peripheral section (2), the centre section (3) having a depth and a width which are substantially larger than the depth(s) and width(s) of the peripheral section(s) (2). If air bubbles are formed in the system this design of the inlet section will allow a flow of liquid to enter the shallower parts of the flow channel, while the air bubbles are confined to the deeper parts of the flow channel. Thereby air bubbles are prevented from entering the flow restrictor (1), thereby reducing the risk of air bubbles blocking the flow path through the flow restrictor (1). Simultaneously liquid is allowed to flow into the flow restrictor (1) substantially unaffected by the air bubble. Accordingly the flow system operates in a very reliable manner.

### CROSS REFERENCE TO RELATED APPLICATIONS

This application is entitled to the benefit of and incorporates by reference essential subject matter disclosed in International Patent Application No. PCT/DK2007/000361 filed on Jul. 14,2007 and Danish Patent Application No. 2006 00998 filed Jul. 20, 2006.

### FIELD OF THE INVENTION

The present invention relates to a flow system, in particular a micro fluidic system, comprising a flow restrictor. More particularly, the present invention relates to a flow system which operates in a more reliable manner than similar prior art flow systems.

### BACKGROUND OF THE INVENTION

A flow restrictor positioned in a flow system is normally a part of the flow path having smaller cross sectional dimensions than the major part of the flow path. Thereby the flow of fluid through the part of the flow path defined by the flow restrictor is restricted as compared to the remaining part of the flow path. Flow restrictors are normally designed with consideration to the desired flow restricting properties. Thus, the dimensions of a flow restrictor will normally be chosen to match a specific desired flow restriction for that specific application.

Flow restrictors may be constructed by inserting small sections of capillary tubes in the flow paths. Such capillary tubes may advantageously be made from a glass material. Another possibility is to form the flow restrictor directly in the flow path. This is, e.g., an advantage if the flow system is manufactured using a moulding technique.

Adjacent to and fluidly connected to a flow restrictor there will be an inlet section of the flow path for leading fluid into the flow restrictor and an outlet section of the flow path for leading fluid away from the flow restrictor. Accordingly, the inlet section is positioned upstream relatively to the flow restrictor, and the outlet section is positioned downstream relatively to the flow restrictor.

When liquid is transported through the flow system, care must be taken at the inlet section in order to avoid that air bubbles enter the flow restrictor, thereby blocking the flow of liquid through the flow restrictor. This is particularly a problem when the flow system is a micro fluidic system where the cross sectional dimensions of the flow restrictor are normally so small that an air bubble will have difficulties in passing the flow restrictor, and therefore, once having entered the flow restrictor, may block this, and thereby prevents further liquid flow through the flow system. This is very undesirable because it leads to a flow system which operates in an unreliable manner.

### BRIEF SUMMARY OF THE INVENTION

It is, thus, an object of the invention to provide a flow system with a flow restrictor, where the flow system can be operated in a more reliable manner than similar prior art flow systems.

It is a further object of the invention to provide a flow system with a flow restrictor in which air bubbles are prevented from entering the flow restrictor.

It is an even further object of the invention to provide a micro fluidic system with a flow restrictor, where the micro fluidic system can be operated in a more reliable manner than similar prior art micro fluidic systems.

According to the invention the above and other objects are fulfilled by providing a flow system having a base part with at least one flow path formed therein and a lid part being attached to the base part in such a manner that it covers the flow path(s), the flow path(s) comprising:

a flow restrictor,

a flow channel comprising an inlet section positioned upstream relatively to the flow restrictor,

wherein the flow channel, at least at the inlet section, has a cross section defining at least two distinct depths of the flow channel.

The base part is preferably a substrate in which the flow path(s) is/are formed. It may be made from a polymer material, including, but not limited to, polystyrene (PS), polyethylene terephtalate glycol (PETG), cyclic olefin copolymer (COC), and/or any other suitable polymer material. Alternatively, the base part may be made from another suitable material which is not a polymer. The flow path(s) may be formed in the base part using any suitable kind of technique, such as etching or hot embossing, or the base part may be manufactured using an injection moulding technique, the flow path(s) in this case being formed in the base part during the manufacturing process. Alternatively, any other suitable technique known per se in the art may be used for forming the flow path(s). The flow path(s) will normally be formed in a surface part of the base part.

The lid part is a part of the flow system which is manufactured separately and attached to the base part after the flow path(s) has/have been formed. Thereby the lid part covers and seals the flow path(s), and closed flow channels are formed. The lid part may also be made from a polymer material, including, but not limited to, polystyrene (PS), polyethylene terephtalate glycol (PETG), cyclic olefin copolymer (COC), and/or any other suitable polymer material. Alternatively, the lid may be made from another suitable material. It may, e.g., be a metal film, e.g. made from aluminium or from another suitable metal.

In the present context the term ‘flow path’ should be interpreted to mean a path in the flow system along which a flow of fluid, preferably liquid, is allowed to flow.

As described above, a flow restrictor is a part of the flow system where the fluid flow is restricted, often due to a reduced size and/or a different shape of the cross section of that particular part of the flow path.

The flow channel forms part of the flow path, i.e. fluid may flow through the flow channel. The inlet section is a part of the flow channel which is positioned in fluid connection with the flow restrictor, and preferably immediately adjacent to the flow restrictor. However, the inlet section may alternatively be positioned at some distance from the flow restrictor. Since the inlet section is positioned upstream relatively to the flow restrictor, it will be the part of the flow channel which leads fluid into the flow restrictor. It should be noted that in the present context the term ‘upstream’ should be interpreted in the following manner. When a first point in the flow path is positioned upstream relatively to a second point in the flow path, a fluid running in the flow path will reach the first point before it reaches the second point.

At least the inlet section of the flow channel has a cross section which defines at least two distinct depths of the flow channel. In the present context the term ‘cross section’ should be interpreted to mean a cross section of the flow channel along a direction having a component which is perpendicular to the flow direction of fluid through the flow channel. The cross section is preferably at least substantially perpendicular to the flow direction.

The depth of the flow channel at a specific position in the cross section is a representative distance from a surface part of the base part to the bottom of the flow channel at the specific position. Thus, since the cross section defines at least two distinct depths of the flow channel, there will be at least two different positions where the distance from a surface part of the base part to the bottom of the channel in a first position will be distinctively larger than the distance from a surface part of the base part to the bottom of the channel in a second position. Thus, the flow channel comprises ‘shallower parts’ and ‘deeper parts’. In the present context the term ‘distinct’ should be interpreted to mean that the difference between the depths is clearly measurable.

It is an advantage that the cross section of the flow channel, at least at the inlet section, defines at least two distinct depths of the flow channel. In the case that an air bubble is formed in a flow of liquid, the surface tension of the air bubble may prevent it from entering the shallower parts of the flow channel if the flow channel is designed in an appropriate manner. Thereby it will be confined to the deeper parts, and by designing the inlet section appropriately, the air bubble may be prevented from entering the flow restrictor, and blocking of the flow restrictor by air bubbles is thereby prevented. Simultaneously, the fluid is not prevented from entering the shallower parts of the flow channel and it may therefore pass an air bubble confined in a deeper part, and thereby enter the flow restrictor.

Accordingly, in a flow system according to the invention blocking of the flow restrictor by air bubbles is prevented while liquid is allowed to flow into the flow restrictor. Thus, the operation of the flow system is not interrupted, and a more reliable operation of the flow system is obtained. This is very advantageous.

In a preferred embodiment the flow system may be a micro fluidic system. In the present context the term ‘micro fluidic system’ should be interpreted to mean a system having dimensions which are sufficiently small to at least substantially prevent turbulence in a fluid flowing in the system.

In a micro fluidic system the problems described above regarding air bubbles blocking flow restrictors are particularly relevant because of the small dimensions of the flow channels relatively to the expected size of an air bubble formed in a liquid flow. Accordingly, the present invention is of particular relevance when the flow system is a micro fluidic system.

The cross section of the flow channel, at least at the inlet section, may define a centre section and at least one peripheral section, the centre section having a depth and/or a width which is/are substantially larger than the depth(s) and/or the width(s) of the peripheral section(s). According to this embodiment the centre section forms a ‘deeper part’ of the flow channel, and each peripheral section forms a ‘shallower part’ of the flow channel. According to this embodiment the flow channel is provided with a relatively deep centre section and at least one shallower ‘wing’ positioned peripherally in the cross section. Preferably, the centre section is flanked by wings on either side. The peripheral sections may have the same depth, or they may have slightly different depths, as long as the depth of the centre section is substantially larger than the depth of each of the peripheral sections.

The dimensions of the peripheral section(s) may be sufficiently large to allow a flow of liquid to pass there through, and/or the dimensions of the peripheral section(s) may be sufficiently small to prevent an air bubble from entering the peripheral section(s). According to these embodiments an air bubble formed in a flow of liquid will be confined to the deeper centre section while a flow of liquid is allowed to run via the shallower peripheral section(s), thereby passing the air bubble and entering the flow restrictor. Thus, the flow of liquid through the flow system is not impaired by the presence of an air bubble, and a very reliable operation of the flow system is thereby obtained.

In a preferred embodiment the depth of the centre section may be within the interval 200 μm to 300 μm, such as within the interval 210 μm to 280 μm, such as within the interval 220 μm to 250 μm, such as approximately 230 μm.

Similarly, the depth of the peripheral section(s) may preferably be smaller than 100 μm, such as within the interval 5 μm to 100 μm, such as within the interval 10 μm to 50 μm, such as approximately 20 μm.

The inlet section may be arranged immediately upstream relatively to the flow restrictor. This should be understood in such a manner that the inlet section is fluidly coupled directly to the flow restrictor. According to this embodiment, any air bubbles being present in a flow of liquid flowing in the flow channel will be trapped as described above before the flow of liquid enters the flow restrictor.

Furthermore, it is ensured that no air bubbles can be formed in the flow channel between the inlet section and the flow restrictor, because the inlet section is fluidly coupled directly to the flow restrictor, i.e. there is no flow channel between these two parts.

The flow channel may, at least at the inlet section, have a cross section defining at least a first region having a first depth and a second region having a second depth, the first depth being significantly larger than the second depth. According to this embodiment, any air bubbles present in a flow of liquid flowing in the flow channel, will be confined to the first region, while being prevented from entering the second region, as explained above.

The depth of the flow channel may preferably be substantially constant at the first depth throughout the first region and substantially constant at the second depth throughout the second region, thereby defining a stepwise boundary between the first region and the second region. According to this embodiment, the cross section of the flow channel, at least at the inlet section, resembles a step function with a discontinuity at a position corresponding to the boundary between the first region and the second region. Thus, the bottom of the flow channel is preferably flat throughout the first region and throughout the second region, but the depth of the flow channel changes abruptly and significantly at a position corresponding to the boundary between the first region and the second region. The abrupt change in depth at the boundary between the first region and the second region has the consequence that any bubbles present in the flow of liquid is more easily confined to the first region and prevented from entering the second region.

It should be noted that the cross section of the flow channel may define further regions having distinct depths.

### BRIEF DESCRIPTION OF THE DRAWINGS

The invention will now be described in further details with reference to the accompanying drawings in which

FIG. 1 illustrates five different flow systems according to embodiments of the invention in a view from above, and

FIG. 2 is a cross sectional view of a flow channel in a flow system according to an embodiment of the invention.

### DETAILED DESCRIPTION OF THE PREFERRED EMBODIMENTS

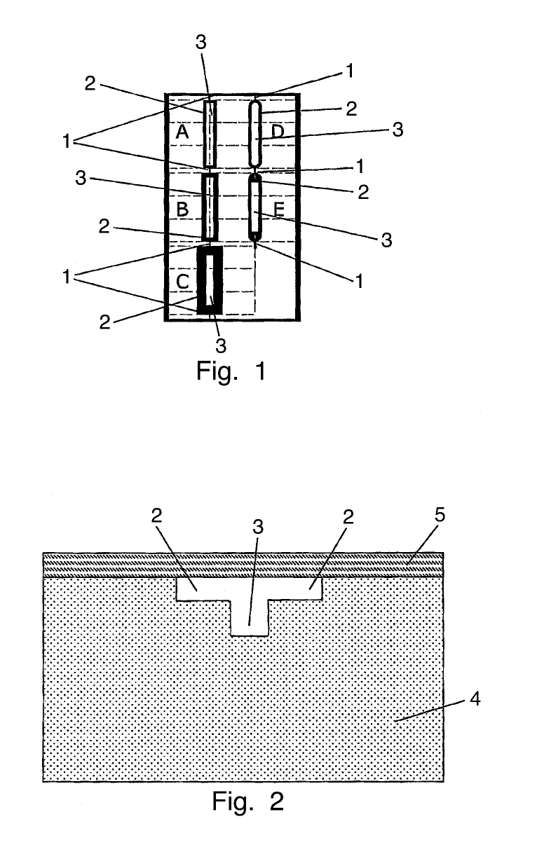

FIG. 1 illustrates five different flow systems A, B, C, D, E according to various embodiments of the invention in a view from above. Each of the flow systems A, B, C, D, E is connected to a flow restrictor 1, illustrated by a very small cross sectional area. For each of the flow systems A, B, C, D, E the dark areas represent shallower peripheral sections 2, and the white areas represent deeper centre sections 3.

The various flow systems A, B, C, D, E represent varying dimensions and shapes of the cross section of the flow channel. In flow systems A, D, and E the peripheral sections 2 are very narrow relatively to the centre section 3. In flow systems B and C the peripheral sections 2 are somewhat wider, thereby allowing a larger flow of liquid through the peripheral sections 2 in case the centre section 3 is blocked by an air bubble. The width and depth of the peripheral sections 2 should be selected in such a manner that a relatively low-resistant flow path is established for the liquid while a possible air bubble is prevented from entering the peripheral sections 2.

FIG. 2 is a cross sectional view of an inlet section of a flow channel in a flow system according to an embodiment of the invention. The cross section intersects the flow channel substantially perpendicularly to the flow direction of a flow of liquid through the flow channel. The flow system comprises a base part 4 having a flow channel formed in a surface part thereof. The flow channel comprises a deeper centre section 3 flanked by two shallower peripheral sections 2. It is clear from FIG. 2 that the depth of the peripheral sections 2 is much smaller than the depth of the centre section 3. It also appears from FIG. 2 that the depth of the flow channel at the centre section 3 is substantially constant, and that the depth of the flow channel at each of the peripheral sections 2 is also substantially constant. Due to the significant difference in depth between the centre section 3 and each of the peripheral sections 2, a discontinuous and abrupt boundary is formed between the centre section 3 and each of the peripheral sections 2. As explained above, this geometry is very suitable for ensuring that air bubbles present in a flow of liquid flowing in the flow channel are confined to the centre region 3 and prevented from entering the peripheral regions 2.

A lid part 5 is arranged on the base part 4 in such a manner that it closes and seals the flow channel.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A flow system having a base part with at least one flow path formed therein and a lid part being attached to the base part in such a manner that it covers the flow path(s), the flow path(s) comprising:
a flow restrictor,
a flow channel comprising an inlet section positioned upstream relatively to the flow restrictor,
wherein the flow channel, at least at the inlet section, has a cross section defining at least two distinct depths of the flow channel.

2. The flow system according to claim 1, wherein the flow system is a micro fluidic system.

3. The flow system according to claim 1, wherein the cross section of the flow channel, at least at the inlet section, defines a centre section and at least one peripheral section, the centre section having a depth and/or a width which are substantially larger than the depth(s) and/or the width(s) of the peripheral section(s).

4. The flow system according to claim 3, wherein the dimensions of the peripheral section(s) are sufficiently large to allow a flow of liquid to pass there through.

5. The flow system according to claim 3, wherein the dimensions of the peripheral section(s) are sufficiently small to prevent an air bubble from entering the peripheral section(s).

6. The flow system according to claim 1, wherein the inlet section is arranged immediately upstream relatively to the flow restrictor.

7. The flow system according to claim 1, wherein the flow channel, at least at the inlet section, has a cross section defining at least a first region having a first depth and a second region having a second depth, the first depth being significantly larger than the second depth.

8. The flow system according to claim 7, wherein the depth of the flow channel is substantially constant at the first depth throughout the first region and substantially constant at the second depth throughout the second region, thereby defining a stepwise boundary between the first region and the second region.
